(19) United States
(12) Patent Application Publication
(10) Pub. No.: US 2024/0428260 A1
(43) Pub. Date: Dec. 26, 2024

(54) ARTIFICIAL INTELLIGENCE-POWERED CONTEXTUAL CUSTOMER SERVICE THROUGH LOGIC TREES ENHANCED WITH MISSION AND CORPORATE VALUES BASED INTERACTIONS USING GENERATIVE AI PROMPTS TO CONTROL RESPONSES WITH BRAND CHARACTERISTICS AND TONE

(71) Applicant: GLADLY SOFTWARE INC., SAN FRANCISCO, CA (US)

(72) Inventors: Theodore Mico, Venice, CA (US); Evan Gregory Tann, Santa Monica, CA (US); Michael Block, Los Angeles, CA (US); Zachi Cohen, Los Angeles, CA (US)

(21) Appl. No.: 18/739,015

(22) Filed: Jun. 10, 2024

Related U.S. Application Data
(60) Provisional application No. 63/522,923, filed on Jun. 23, 2023.

(51) Int. Cl. G06Q 30/015

(52) U.S. Cl. CPC G06Q 30/015

(57) ABSTRACT

Systems, devices, and methods are disclosed herein of an artificial intelligence-powered contextual customer service automation solution using logic trees enhanced with the mission and corporate values-based generative AI prompts to control responses with brand characteristics and tone.

### RELATED APPLICATION

The present application is a non-provisional application of and claims the benefit of U.S. Provisional Patent Application No. 63/522,923, filed Jun. 23, 2023, and entitled “ARTIFICIAL INTELLIGENCE-POWERED CONTEXTUAL CUSTOMER SERVICE THROUGH LOGIC TREES ENHANCED WITH MISSION AND CORPORATE VALUES BASED INTERACTIONS USING GENERATIVE AI PROMPTS TO CONTROL RESPONSES WITH BRAND CHARACTERISTICS AND TONE”, which is incorporated by reference in its entirety.

### FIELD

This disclosure relates generally to consumer goods and services technology, and, more particularly, to the artificial intelligence-powered contextual customer service through logic trees enhanced with mission and corporate values-based interactions using generative AI prompts to control responses with brand characteristics and tone.

### BACKGROUND

An enterprise (e.g., a business, an organization, a brand, etc.) may provide a customer experience platform to engage with its customers at every point of their buying journey. The customer experience platform may encapsulate everything the enterprise does to put customers first, managing their journeys and serving their needs. The customer journey may include steps from marketing to sales to customer service and each step in between. The customer's perceptions and feelings resulting from interactions with the brand's products and/or services may help the brand and/or enterprise stand out from its competitors. However, the customer experience platform may lack easy customization of its workflow to deliver personalized customer experiences to its varied audience. The customer experience platform may be unable to give a positive and engaging experience due to complicated process flows that may be difficult to redesign and/or reframe in order to evolve for a better customer journey and/or to build a sustainable brand relationship.

In addition, the customer experience platform may not be trained and/or configured to sufficiently generate an appropriate response to a customer based on the internal process of the enterprise and its brand value which may eventually upset the customer by not resolving their issue. The enterprise may face low customer satisfaction due to delayed responses and/or ineffectiveness in resolving time-sensitive issues. The potential customer may deflect to another service provider and/or a different brand in the absence of an appropriate and/or timely response to the customer's request leading to loss of business and/or customer dissatisfaction.

### SUMMARY

Systems, devices, and methods are disclosed herein of an artificial intelligence-powered contextual customer service automation solution using logic trees enhanced with the mission and corporate values-based generative AI prompts to control responses with brand characteristics and tone.

In some embodiments, a method includes creating a customer response flow having one or more pre-built templates for handling responses for a brand, each of the one or more pre-built templates having a series of step-by-step actions with controls and generative artificial intelligence (AI) response prompts; receiving a query from a user through a dynamic chatbot; determining user intent and context information based on the query; identifying a workflow path to respond to the customer, based on the user intent and context information, from one or more pre-built templates; and performing one or more actions to execute the customer response flow based on a set of one or more brand values and one or more policy rules set forth in the one or more pre-built templates to respond to the request.

In some other embodiments, a tangible, non-transitory, computer-readable media having instructions thereupon which, when executed by a processor, cause the processor to perform a method having: creating a customer response flow having one or more pre-built templates for handling responses for a brand, each of the one or more pre-built templates having a series of step-by-step actions with controls and generative AI response prompts; receiving a query from a user through a dynamic chatbot; determining user intent and context information based on the query; identifying a workflow path to respond to the customer, based on the user intent and context information, from one or more pre-built templates; and performing one or more actions to execute the customer response flow based on a set of one or more brand values and one or more policy rules set forth in the one or more pre-built templates to respond to the request.

In some other embodiments, a computer-based flow server for customer assistance includes: a memory and a process engine coupled to the memory to: create a customer response flow having one or more pre-built templates for handling responses for a brand, each of the one or more pre-built templates having a series of step-by-step actions with controls and generative AI response prompts; receive a query from a user through a dynamic chatbot; determine user intent and context information based on the query; identify a workflow path to respond to the customer, based on the user intent and context information, from one or more pre-built templates; and perform one or more actions to execute the customer response flow based on a set of one or more brand values and one or more policy rules set forth in the one or more pre-built templates to respond to the request.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The appended drawings illustrate examples and are, therefore, exemplary embodiments and not considered to be limiting in scope.

FIG. 1 is a network view of a process engine illustrating generation of an intuitive computerized response to a customer's request through logic trees enhanced with mission and corporate values based interaction of the customer through a brand process flow server, according to some embodiments.

FIG. 2 is a network view of the process engine of FIG. 1, according to some embodiments.

FIG. 3 is a graphical flow diagram illustrating the steps involved in generating a workflow response for a customer's query based on the brand value(s) and brand mission by the process engine of FIG. 1, according to some embodiments.

FIG. 4A is a user interface view illustrating an exemplary use-case scenario of the process engine of FIG. 1, according to some embodiments.

FIG. 4B is another user interface view illustrating the continuation of the exemplary use-case scenario of the process engine of FIG. 1, according to some embodiments.

FIG. 5A-5H is an interactional user interface view of the process engine of FIG. 1.

FIG. 6A-6C is a user interface view illustrating an exemplary use-case scenario of the process engine of FIG. 1 to configure a workflow for tracking an order using its policy builder and response builder features, according to some embodiments.

FIG. 7 is a process flow detailing the operations involved in setting up an artificial intelligence-powered contextual customer service through logic trees enhanced with a mission and corporate values-based interactions of the process engine of FIG. 1 using generative AI prompts to control the responses, according to some embodiments.

### DETAILED DESCRIPTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Systems, devices, and methods are disclosed herein of an artificial intelligence-powered contextual customer service automation solution using logic trees enhanced with the mission and corporate values-based generative AI prompts to control responses with brand characteristics and tone.

In one aspect, the disclosed system includes a process engine that uses generative AI to initiate a human-like response in conversation with a customer to build brand engagement and elevate a customer experience. The process engine may automate customer service interactions, provide virtual assistance, and enable natural language search through its AI models.

The process engine of the disclosed system may enable a brand to solve a customer problem and respond to the customer's request. The process engine may allow brands to describe their end-customer journey through text by assembling a series of step-by-step actions along with controls and generative AI response prompts to express brand policies, voice, and mission. The logic trees needed to run the process engine may be automatically created in the background. The process engine may enable a brand and/or a company to define a customer journey via templates that comprise a series of actions and rules/conditions that shape unique responses and policies. The process engine may be a process to assemble a user-focused story-driven chronological view of a customer journey that removes the complexity of a traditional logic tree UI and substitutes it with easy-to-understand building blocks called “actions” that can be sequenced in a logical, error-proof order.

The process engine may include a logic tree for the purpose of automating customer service using AI. Once a customer message is received by the process engine, the process engine may use AI to evaluate the message. Based on the AI analysis, the process engine may decide on different paths to take, and execute those paths, which effectively implements a process for the brand. The process engine may use a neural network of trained data sets (e.g., LLM, e-commerce, etc.). The neural network may look at all of its past experiences, and it may formulate on the fly, a semantic analysis of what the words mean, and then come up with a suggested path without human intervention through artificial intelligence. The path may be somewhat dynamic but mostly the path is encoded in this process flow. The suggested path may be directly edited by the AI based on the brand's pre-defined policy. The AI may be used within that path and also to direct it to the correct path.

For example, a customer of a cosmetics company may want to return a product. The process engine may implement a step-by-step journey (e.g., actions) to process the return. The process engine may ensure that the product is within the service level agreement (SLA) of the brand. The process engine may pull in order data from the back-end systems, reply back to the customer that the system may need more information from the customer, understand their response, reply in a personalized and contextual manner in the brand's voice and/or tone, and ultimately process the entire return.

The process engine may focus on natural language processing, understanding, and allowing machines to interact with humans naturally. The artificial intelligence of the process engine may generate content including text, images, audio, video, code, and/or synthetic data to resolve the customer's problems in conformance with the brand's value and/or mission.

The process engine may deliver hyper-personalized interactions for e-commerce and/or retail customers. The process engine may include a no-code customer experience builder (e.g., a flow builder) that may take control of conversations with the customers. The no-code customer experience builder using the generative AI may allow brands to blend the personalized and contextual responses with unique policy controls.

The process engine may create customer service workflows in a few easy steps. The process engine may allow the creation of conversation flow for each contact reason, setting brand policies, previewing the experience, and publishing with workflow for an improved customer experience. The process engine may allow its users to build customer response flows quickly and implement a cost-effective support solution while experiencing quicker time-to-value. The process engine may allow the non-technical users to modify and maintain the complex brand policies and response prompts easily to meet changing customer expectations and evolving brand policies and responses.

The process engine may allow a user (e.g., an enterprise, a brand, etc.) to assemble complex behaviors from simple story-telling action components, such as “Look up order” or “Track shipments” and the logic of “What should happen if the customer and/or can't be found under their email?” is abstracted away and handled automatically for them. The process engine may not require code to deploy it. All the logic necessary to perform workflow steps of a brand and/or an enterprise may be generated in the background by the process engine.

The brand and/or company may build customer service journeys that can answer specific end-customer problems and/or inquiries by picking from a selection of pre-built flow templates of the process engine. The pre-built flow template may include actions and/or alternatively, brands may choose to create a customer journey and/or unique flow of their own using the available components from an action library. The action categories to choose from may include premium, standard, custom and/or recommended among other potential categories. The actions of the process engine may be modified using sub-actions to change the behaviors of the flow and adapt the customer journey based on brand-defined generative AI prompts and controls of the process engine.

The interaction between “Actions” and “Rules” may alter the behavior of the process engine to create a customizable and/or personalized customer journey.

A user interface of the process engine may enable the action to be modified via a rules engine (e.g., using policy rules) allowing additional behavior in an existing action and/or a change in existing behavior without a flow and/or logic tree which might otherwise have branching visible to the user.

Response language to the end customer may also be modified via this rules interface. The response may be dynamically modified based on conditions set by the brand using the process engine. For example, different responses may be based on end-customer sentiment, lifetime value, and/or customer service history with the brand. The output response may be assisted using generative AI and that generative AI may include the parameters such as brand voice, tone, and/or values. Each of these parameters may be adjusted by the brand through a configurator of the process engine.

The brand users (e.g., brand owner, enterprise, etc.) may pick from templates that contain a series of actions and/or related sub-actions that comprise a flow. The brand users may configure these actions and set rules and/or conditions to alter the responses of the process engine. The process engine may allow dynamic changing of the controls in a flow and/or an action based on selections made and/or modifiers applied.

The process engine may allow using finite-state machine, and other forms of logic/structures. The process engine may include some of the Greek symbols (E, I′) around FSMs (finite-state machine or finite-state automaton), enable extra controls, and additional logic to handle extra situations, and/or use cases.

The core feature of process engine “actions” may be used to build the desired experience for a particular contact reason. For example, a lookup action and track shipment action may specify the track order contact reason flow of the process engine. The “actions” may be modified to create an alternate response and/or condition to resolve a particular end-customer use case.

In another aspect, a filter data action of the process engine may allow brands to intelligently filter any data associated with the end customer like multiple subscriptions, orders, shipments, products, etc. based on information the customer provides. The user (e.g., brand owner, enterprise, etc.) may filter the inquiries by question, message, and/or rule. For example, if the brand user wants something very specific-they may use a ‘filter by question’ sub-action. If the brand user wants a broader filter net, the brand user may use a ‘filter by user’ message sub-action. The filter data action may keep filtering until there are no further conditions on which to filter. For example, if a customer has 3 subscriptions, the first filter might be based on whether the subscription is billed annually, and the second filter might be based on whether the subscription is for a specific product. There may be anywhere between 0-3 matches for those filters.

Filter by user message may be used if a brand user wants to cast a wide net. For example, if the end-customer responds to a question with “the order with red dress shipped to Jimmy at 123 Main st”. The process engine may view it as a “product” shipped to “name” at “address” using named entity recognition. The process engine may take all entities in the message and try to best match field in the data array. Filter by user message will run on every interaction during the filtering process until there are no further conditions to filter on.

Using the filter by question action, the process engine may look at a specific field only, such as email and/or order number. The filter may only work if an email or order number is available. The ‘filter by question’ feature may need email at the minimum.

‘Filter by user message’ may or may not need to be combined with ‘filter by question feature. ‘Filter by rule’ of the process engine may help limit what the brand user is looking for (e.g., order from less than 2 weeks ago). Filter by rule may omit and/or include only data that matches certain criteria. If the rule is set up to include orders which were placed within the past two weeks, only those orders would be included after filtering. The same result would follow if the contrapositive of that rule were used (e.g., omit orders which were not placed within the past two weeks). Both options are possible with the ‘filter by rule’ system. Rules can also be chained together using typical AND/OR logic.

The filter data function of the process engine may ask questions until it narrows the orders/subscriptions down to a single item (or product, etc.). The filter data function may optionally use generative AI to better understand the end-customer responses and improve follow-up questions to get the desired response and/or information quickly.

For example, if a user mentions the order they want a refund for has “2 pants” in it, but it's labeled as “slacks” by the brand (or in the order management system), the process engine may still be able to understand and identify the correct product and/or order. Questions may be pre-generated, canned, and/or generated dynamically by the process engine.

The process engine may build an entire flow and/or process map that may be dynamic per request and/or done once by the brand during setup. The brand may approve, modify and/or review to deploy it. The flow builder may be generated dynamically and/or presented ahead of time for approval by the brand manager and/or by request.

For example, the workflow may be generated by voice (e.g., using microphone), text-based prompt (e.g., written instructions), form/fields filled out, and/or mind control. The process review may be dynamic with required reviews based on some statistically significant confidence measurement

The process engine may include an “Analyze Message” action to enable a topic detection using generative AI or other technology. The flow builder of the process engine may build an entire flow and/or process map that may be dynamic per request and/or done once by the brand during setup. The process engine may include a response builder to create macros for intro/outro generated responses that may use generative AI to rephrase.

The process engine may include an agent assist actions to generate recommended responses and summaries for review during live conversations with end-customers using generative AI. The agent assist actions application may ask for an “updated response suggestion” based on a number of criteria (e.g., by taking into consideration the customer information).

The action and/or sub-action of the process engine may support: adding on to change underlying behavior so-more specific use cases may be addressed in the same flow, moving from happy path to not happy path (e.g., unexpected) scenarios, allowing for additional complexity in responses without having to build a new flow. The sub-actions may be unique to a given action and are always nested under a main (e.g., parent) action.

The auto-process engine may include a configuration program that may natively integrate with an existing conversational software application of an enterprise to automatically generate a response based on an end-customer's (e.g., user) interaction and disposition with the system through its conversational software application (e.g., dynamic chatbot). For example, various embodiments may pull customer and order data from other systems beyond OMS such as helpdesks or contact center software, which may include integrations with shipping platforms, return services, subscription platforms, and/or Customer Relationship Management (“CRM”) systems among other systems.

In alternative embodiments, the disclosed solutions could be applied to booking systems, reservation systems, and point of purchase systems, among other systems that contain but are not limited to customer and order information.

The disclosed system may use artificial intelligence (AI) and natural language processing (NLP) to understand customer questions and automatically generate a set of most relevant “actions” that would help achieve an optimally intuitive response to the customer's request based on the customer's circumstances and/or behavior. Further, the disclosed process engine may automatically change the selection and/or order of flow-based options within the dynamic chatbot and/or other text-based communication medium/channel.

The disclosed system may combine different subsystems of the existing order management system of an enterprise to make all the data from customer interaction readily available for the process engine to be quickly trained through deep learning methods to dynamically generate the response. The dynamically generated response may lead to a successful outcome in resolving the customer's problem.

The algorithm of the process engine disclosed system may use knowledge of the customer's disposition via integration with enterprise systems (e.g., OMS/CROM/data centers) and apply machine learning methods to the historical data and/or customer interactions to initiate a workflow response. The process engine may predict the most likely context-based workflow options that will lead to a successful outcome for the customer.

The disclosed system may use a neural network, other machine learning, and/or statistical approaches to make smarter decisions on which smart options to be displayed in the limited real estate in a chatbot scenario to improve the customer journey and customer satisfaction scores (e.g., NPS, CSAT, customer satisfaction scores, etc.). The disclosed system may automatically hide the less likely smart options.

The disclosed system may work within any-based channel such as chatbot, SMS, email, and/or in-app channel, etc. In SMS, the process may offer text-based choices. The disclosed system may be designed to simulate a conversation with a customer through artificial intelligence, who may interact with users by text and/or email, etc.

In another aspect, the process engine of the disclosed system may allow the system to create and/or modify a workflow. For example, there may be a track order flow in the disclosed system.

Once a customer of a brand using the process engine enquires about his/her order in the “track shipment”, the process engine may look for the shipment and may have all information of the customer and the shipment from its order management system. The rules configurator of the disclosed system may generate a unique workflow and/or response for “in transit” or “delivered” status scenarios. Since the disclosed system includes an artificial intelligence-based workflow configurator, the system may be able to identify the specific use case as “in-transit” in the order management system.

In one exemplary embodiment, a server-implemented framework is disclosed which automates the discovery and negotiation of product and service sales online and offline based on buyer- and seller-defined parameters and elasticity thresholds. Artificial intelligence (AI) negotiation agents operate on behalf of the buyers and sellers to recommend potential options, automatically and anonymously negotiate towards the best satisfaction and outcome for their respective users based on the parameters set by the users to be important and also based on market conditions. The AI negotiation agents join a multi-stage negotiation session until sufficiently improved recommendations are obtained for particular products and/or services. These negotiated, improved, offers are then transmitted to the buyers and sellers for acceptance. The AI agent for sellers optimizes sales strategy and effectiveness while the AI agent for buyers improves purchasing decision-making to enable better outcomes (financial, customer satisfaction, experience, etc.) with minimal effort.

The examples disclosed herein generally relate to an AI-powered framework whereby autonomous AI agents recommend outcomes using a workflow configurator on behalf of buyers and sellers. The buyers and sellers may communicate using the disclosed framework in an optimized way that allows various aspects of decisions (e.g., purchasing decisions) to be negotiated and adjusted nearly instantly. In some examples, the consumers use their client devices (e.g., laptop, smartphone, tablet, etc.) to anonymously organize and set up automated, ongoing recommendation plans executed by multi-criteria decision-making negotiation agents on a server, referred to herein as “buyer AI negotiators” (“AI buyers,” “AI buyer agent,” “consumer bot,” or “purchasing bot” for short), for purchasing particular products or services, either online or through physical kiosks or storefronts. The various manifestations may be embodied in the physical response configurator at hardware. At the same time, some examples allow retailers to set up automated, ongoing recommendation terminals or selling campaigns executed by multi-criteria decision-making negotiation agents on a server, referred to herein as “seller AI negotiators” (or “AI sellers” or “AI seller agent” for short), that offer the seller's products or services and automatically recommendation with the buyer AI negotiators. The various embodiments may operate by combining large data sets of customer and consumer data from internal and/or external sources within an organization and applying intelligent, iterative processing algorithms to learn from patterns and features in the data that they analyze. The various embodiments may apply any one or more of the following:

Machine Learning—A specific application of AI in the embodiments described herein lets kiosks, point of purchase, and chatbots embodying the smart indicators generated through technologies described herein learn automatically and develop better results based on experience, all without being programmed to do so. These technologies permit the AI described herein to find patterns in data, uncover insights, and improve the recommendations of whatever task the system has been set out to achieve.

Deep Learning—A specific type of machine learning in the embodiments described herein allows AI to learn and improve by processing data. Deep Learning uses artificial neural networks which mimic biological neural networks in the human brain to process information, find connections between the data, and come up with inferences, or results based on positive and negative reinforcement.

Neural Networks in the embodiments described herein may be a process that analyzes data sets over and over again to find associations and interpret meaning from undefined data. Neural Networks in the embodiments described herein may operate like networks of neurons in the human brain, allowing AI systems to take in large data sets, uncover patterns amongst the data, and answer questions about it.

The process engine of the disclosed system may be a logic tree for the purpose of automating the customer service using AI. Hence, when a customer message is received, the process engine of the disclosed system may evaluate the message using artificial intelligence and then decides on different paths it is going to take, and executes those paths, which effectively implements a process for the brand. For example, if a particular customer of a cosmetics company wants to return a product, the process engine of the disclosed system may implement a step-by-step action to process that return. The process engine of the disclosed system may ensure that it's within service level agreement (SLA) and will pull in order data from the back-end systems, reply back to the customer if it needs more information from the customer, analyze/understand their response, and ultimately process an entire return.

Cognitive Computing in the embodiments described herein may be another important component of AI systems designed to imitate the interactions between humans and machines, allowing computer models to mimic the way that a human brain works when performing a complex task, like analyzing text, speech, or images.

Natural Language Processing in the embodiments described herein may be a critical piece of the AI process in the various embodiments by permitting servers and hardware computers to recognize, analyze, interpret, and truly understand human language, either written and/or spoken. Natural Language Processing is critical in the embodiments described herein through an AI-driven system that interacts with humans in some way, either via text and/or spoken inputs.

Computer Vision in the embodiments described herein may enable the ability to review and interpret the content of an image via pattern recognition and deep learning to power the response configurator. Computer Vision in the various embodiments may identify components of visual data, like the captchas you'll find all over the web which learn by asking customers to help them identify scenarios, choices, and navigate complexity, etc.

The embodiments of this invention are illustrated by way of example and not limitation in the figures of the accompanying drawings, in which like references indicate similar elements and in which:

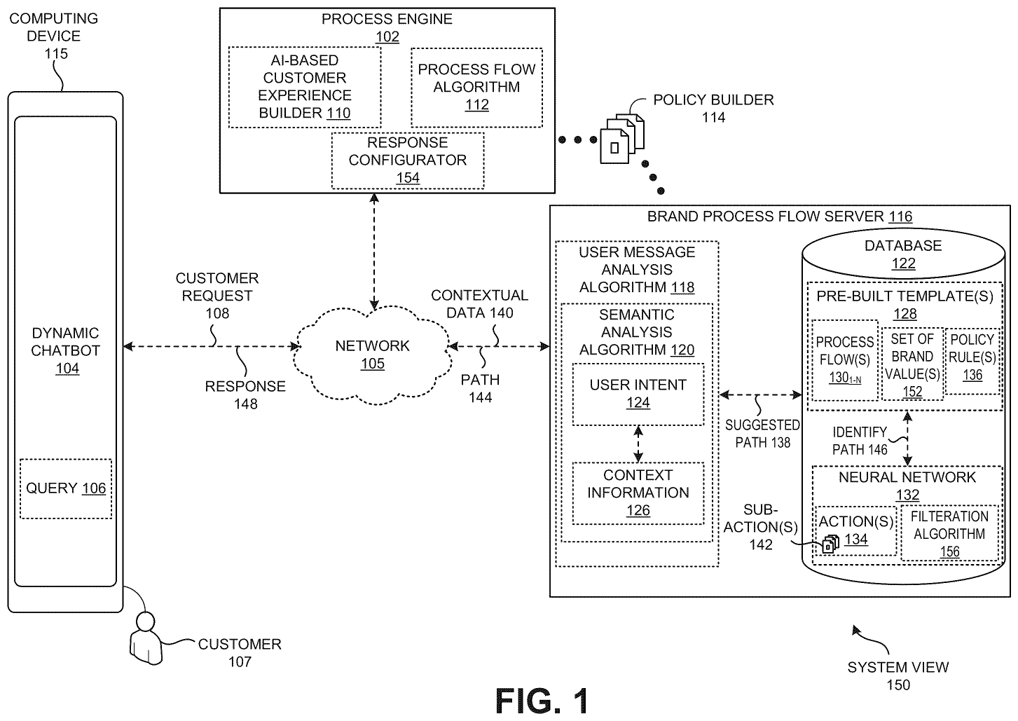

FIG. 1 is a network view 150 of a process engine illustrating generation of an intuitive computerized response 130 to a customer's request 106 through logic trees enhanced with mission and corporate values based interaction of the customer 118 through a brand process flow server 102, according to some embodiments.

Particularly, FIG. 1 illustrates a process engine 102, a dynamic chatbot 104, a query 106, a network 105, a customer 107, a customer request 108, an AI-based customer experience builder 110, a process flow algorithm 112, a response configurator 154, a policy builder 114, a brand process flow server 116, a user message analysis algorithm 118, a semantic analysis algorithm 120, a database 122, a user intent 124, a context information 126, a pre-built templates 128, a brand process flows 130_{1-N}, a set of brand values 152, a policy rule(s) 136, a neural network 132, an action(s) 134, a filtration algorithm 156, an identify path 146, a suggested path 138, a contextual data 140, a sub-action(s) 142, a path 144, and a response 148, according to some embodiments.

The process engine 102 may be an artificial intelligence (AI) based software program capable of automatically generating an intuitive computerized response for a customer 107 of an enterprise and/or a brand so as to execute the foundation and/or crucial task of managing the customer interaction workflow based on its brand mission and/or corporate value(s) to enhance customer experience. The process engine 102 may generate a response 148 for the customer based on artificial intelligence analysis of the customer's message (e.g., query 106). Based on the artificial intelligence analysis, the process engine 102 may decide on a particular path (e.g., path 144, suggested path 138, identify path 146 of the brand process flow server 116) defined in the brand's workflow (e.g., process flow(s) 130 of the brand process flow server 116). Alternatively, process engine 102 may modify (e.g., using modify path 148 of the brand process flow server 116) an existing workflow and/or generate a new workflow using an action library (e.g., action(s) 134).

The process engine 102 may enable the enterprise and/or brand policy makers to quickly generate new content based on a variety of inputs. Input and output of the process engine 102 models may include text, images, sounds, animation, 3D models, and/or other types of data, according to some embodiments.

The dynamic chatbot 104 may be a software program that mimics a conversation with a real person and/or a user (e.g., customer 107) via text and/or voice seeking a service and/or a request from an enterprise through a brand process flow server 116 using the process engine 102. The dynamic chatbot 104 may include a series of graphical and/or language elements that allow for human-computer interaction.

The dynamic chatbot 104 may use machine learning and natural language processing (NLP) techniques to generate more natural and human-like responses and may adapt to the context and evolve over time. The disclosed dynamic chatbot 104 may boost engagement with the customer 107 by generating automated workflow response messages, text, and images when interacting with the customers 107 based on brand policy (e.g., using policy rules 136) and brand mission (e.g., using the set of brand values 152), according to some embodiments.

The query 106 may be a request for data results and/or data from the brand process flow server 116, a request for the data from the brand process flow server 116, and/or both. The query 106 may help the customer get an answer and/or response to a simple question related to a product and/or a service offered by the enterprise and/or brand, perform calculations, combine data from different tables, add, change, and/or delete data from the brand process flow server 116, according to some embodiments. The brand process flow server 116 may generate a response 148 and/or suggest a path (e.g., suggested path 138) for the customer request 108 based on the query 106.

The Network 105 may be a set of computers (e.g., computing device, collection of computers, servers, mainframes, network devices, peripherals, etc.) and/or other electronic devices (e.g., desktop computer, laptop, smart device, etc., used by the customer 107, brand process flow server 116, process engine 102, etc.) that are interconnected for the purpose of exchanging data and/or sharing resources (e.g., over the Internet) located on and/or provided by network nodes. The computing device used by the customer 107 may be communicatively coupled to the brand process flow server 116 and the process engine 102 through the network 105 to request and/or perform various functions related to a product and/or a service provided by the brand and/or the enterprise, according to some embodiments.

The customer 107 may be a recipient and/or a prospective recipient of a good, service, product, and/or an idea offered by the enterprise and/or brand-obtained via a financial transaction and/or in exchange for money and/or some other valuable consideration, according to some embodiments.

The customer request 108 may be a solicitation of data and/or service placed by the customer 107 to an enterprise and/or brand through its brand process flow server 116 using the dynamic chatbot 104, according to some embodiments.

The AI-based customer experience builder 110 of the process engine 102 may be an agile and intuitive custom-build, flexible-innovative cloud communications and workplace solutions tool that may empower an enterprise and/or a brand to quickly create and/or test customer journeys, make real-time updates, and optimize results based on individual customer need to help build and/or establish strong brand awareness. The process engine 102 may build an entire workflow (e.g., process flow(s) 130_{1-N}) and/or process map (e.g., pre-built template(s) 128) that may be dynamic per request and/or done once by the brand during setup using the AI-based customer experience builder 110. The brand may approve, modify, and/or review the entire workflow and/or process map built using the AI-based customer experience builder 110 before it is deployed by the brand, according to some embodiments.

The process flow algorithm 112 may be a set of instructions to be followed for creating an entire internal workflow (e.g., process flow(s) 130_{1-N}) and/or a process map (e.g., pre-built template(s) 128) of a brand and/or an enterprise to help accomplish the task of soliciting the customer request 108, according to some embodiments. The process flow algorithm 112 of process engine 102 may be used to create the entire set of process flow templates (e.g., pre-built template(s) 128) for the brand and/or the enterprise.

The response configurator 154 may be a piece of software used to determine the optimal configuration of an output response 148 for a particular workflow of a brand and/or an enterprise based on brand policy (e.g., using policy rule(s) 136) and/or brand mission (e.g., using the set of brand value(s) 152). Additionally, the response configurator 154 may be used to specify a desired configuration for brand workflow parameters. The output responses of the brand process flow server 116 may be assisted using the process engine 102. Each brand parameter of the brand mission and/or brand values (e.g., brand voice, kind of tone, and manners of the message, text, and content of the response 148) may be adjusted and/or provided control over by the brand using the response configurator 154, according to some embodiments.

The policy builder 114 may be a complete graphical interface for creating and managing the policies that define the exchange of data between connected systems (e.g., brand process flow server 116 and process engine 102). The policy builder 114 may be authorized to build and/or modify the workflow (e.g., process flows 130_{1-N}) for a particular enterprise by creating rules (e.g., policy rules 136) for each workflow of the enterprise and/or the brand. The policy builder 114 may use the interface to monitor, build, and/or modify its various workflow processes (e.g., process flows 130_{1-N}) such as track order workflow, cancel order workflow, etc. to assist its customers. The policy builder 114 may identify the different scenarios based on the workflow process (e.g., process flows 130_{1-N}) to define the brand rules (e.g., policy rules 136). The policy builder 114 may make a query to retrieve data and/or change information in the database 122, such as adding and/or removing data, according to some embodiments.

The brand process flow server 116 may be a computing device and/or a software program that accepts and responds to requests made over a network 105 for other programs and/or devices (e.g., computing device 115) integrated with a conversational software application (e.g., dynamic chatbot 104) of an enterprise and/or a brand to manage response 148 to a customer request 108. The brand process flow server 116 may accept and/or respond to customer requests 108 made over a network 105 by managing and sharing critical organization resources. The brand process flow server 116 may be programmed to primarily execute the processing of customer requests 108, according to some embodiments.

The user message analysis algorithm 118 may be a distinct software program configured to perform a specific task of analyzing and interpreting the keywords and phrases (e.g., query 106) entered by the customer 106. The user message analysis algorithm 118 may be an extension to the semantic analysis algorithm 118 of the brand process flow server 116 dedicated to a specific function of evaluating and interpreting the customer interaction with the brand process flow server 116. The user message analysis algorithm 118 may be programmed to identify the user intent 124 from an ongoing interactional event and derive context information 126 from the customer's input data (e.g., customer request 108). The input data may include a text, a syntax, a slang, a misspelled word, and a query, etc., according to some embodiments.

The semantic analysis algorithm 120 may be a set of instructions to be followed to draw meaning from text. The semantic analysis algorithm 120 may allow the brand process flow server 116 to understand and interpret the query 106 (e.g., sentences, paragraphs, and/or whole documents), by analyzing their grammatical structure and identifying relationships between individual words in a particular context. The semantic analysis algorithm 120 may help the brand process flow server 116 to automatically extract meaningful information from unstructured data, such as emails, support tickets, and customer feedback, etc., according to some embodiments.

The database 122 of the brand process flow server 116 may be an organized collection of structured information that may be easily accessed, managed, and/or updated by the brand process flow server 116. The database 122 may include pre-built templates 128, a process flow(s) 130, a set of brand value(s) 152, a policy rule(s) 136, a neural network 132, an action 134, a sub-action 142, and a filtration algorithm 156.

The user message analysis algorithm 118 of the automated chatbot server 102 may use advanced techniques such as machine learning and natural language processing to understand and respond to a user input (e.g., customer request 108, query 106), according to some embodiments.

The user intent 124 may be the identification and categorization of what a customer 107 intended and/or wanted to find when they typed their search terms (e.g., query 106) into the dynamic chatbot 104 of the process engine 102 for the purpose of brand process flow server 116 optimization and/or conversion rate optimization of the brand process flow server 116, according to some embodiments.

The context information 126 may be the information related to the circumstances in which the transaction event (e.g., customer interaction with the brand process flow server 116) occurred, according to some embodiments.

The pre-built template(s) 128 may be a preset format for a document and/or a file pre-designed by the process engine 102 to define a customer journey. The pre-built template(s) 128 of the process engine 102 may enable a company and/or a brand to define the customer journey via templates that include a series of action(s) 134 and rules/conditions (e.g., policy rule(s) 136), according to some embodiments.

The process flow(s) 130_{1-N} may be a series of step-by-step action(s) 134 that enables the brand and/or company to solve customer problems and/or respond to their requests (e.g., customer request 108, query 106), according to some embodiments.

The set of brand values 152 may be the set of principles and/or standards of behavior that the brand and/or company follows to serve its customers 107. The set of brand values 152 may include the key principles guiding how a company operates, such as where it sources its products, how items are delivered to customers, and/or the way employees are treated. The set of brand values 152 may define precisely how a company operates, achieves its mission statement, and earns money. A few examples of the set of brand values 152 may include how a particular brand, company, and/or enterprise back their customers, make their brand great, how they do what is right, how the brand respect people, embrace diversity, stand for inclusion, win as a team, and support their communities, etc., according to some embodiments.

The policy rule(s) 136 may be the aims and objectives of the brand and/or company that provide a framework for the policy builder 114 to define the regulatory guidelines to take decisions in order to serve its customers 107. The policy rule(s) 136 may describe resource compliance conditions to follow in order to serve its customers 107 and the action 134 to take if a condition is met, according to some embodiments.

The neural network 132 may be a series of algorithms that endeavors to recognize underlying relationships in a set of data (e.g., query 106) derived by the process server 102 through a process that mimics the way the human brain operates. The neural network 132 may be a computational learning system that uses a network of functions to understand and translate a data input in the form of query 106 into a desired output to generate a response 148 based on the semantic analysis (e.g., using the semantic analysis algorithm 120). The neural network 132 may learn from processing many labeled examples (i.e. data=“query 106” with answer=“response 148”) that are supplied during training and using this answer key to learn what characteristics of the input (e.g., query 106) are needed to construct the correct output (e.g., response 136). Once a sufficient number of examples have been processed, the neural network 132 may begin to process new, unseen inputs (e.g., query 106) and successfully return accurate results (e.g., response 136). The more examples and variety of inputs the neural network 132 sees, the more accurate the results may become because the neural network 132 learns with experience, according to some embodiments.

In an example embodiment, the neural network 132 may train the brand process flow server 116 through continuous algorithm enhancement of artificial intelligence-based learning from a large data set. The brand process flow server 116 may receive input query 106 from the customer 107. The neural network 132 may use artificial intelligence and trained dataset to look at all of its past experiences and formulate a semantic analysis on the input query 106 to find out what the words forming the query 106 mean. The neural network 132 may then come up with a suggested path 138 to resolve the query 106 using artificial intelligence, according to some embodiments.

The action(s) 134 may be an event that the brand process flow server 116 performs to execute a customer journey, that is guided by the set of brand value(s) 152 and policy rule(s) 136 and are defined in the pre-built template(s) 128. To answer a specific end-customer problem and/or inquiry (e.g., query 106), the company and/or brand may pick from a selection of pre-built flow templates (e.g., pre-built template(s) 128) consisting of action(s) 134. In an alternate embodiment, the brand process flow server 116 of the company and/or brand may choose to create a customized journey and/or flow of their own using the available action library 308, according to some embodiments.

The filtration algorithm 156 may be a set of instructions to be followed for narrowing down to a single item based on the query 106 and/or customer request 108. The process engine 102 may allow the AI-based customer experience builder 110 to ask questions until it narrows the orders and/or subscriptions down to a single item (e.g., service, product, etc.). The large language model of the process engine 102 may come up with the appropriate questions to achieve some sort of goal with the purpose of filtering a bunch of data using the filtration algorithm 156 based on information that the customer 107 provides. The filtration algorithm 156 may optionally use a generative AI engine to better understand the user responses and improve follow-up questions to get the desired response quickly, according to some embodiments.

The identify path 146 may be the process of establishing and/or locating the best course of action(s) 134 to be followed for resolving and/or replying to the customer's query 106 and/or customer request 108 from the pre-built template(s) 128 of the brand process flow server 116, according to some embodiments.

The suggested path 138 may be the proposed course of action(s) 134 to be followed for resolving and/or replying to the customer's query 106 and/or customer request 108 from the pre-built template(s) 128 of the brand process flow server 116, according to some embodiments.

The context information 140 may be the background information related to the customer 107 that provides a broader understanding of an event and/or item related to the particular customer 107. The context information 140 may be used for framing what the brand process flow server 116 knows in a larger picture. These relevant facts may be utilized to analyze the customer's 107 behavior patterns, thereby improving their experience, according to some embodiments.

The sub-action(s) 142 may be an auxiliary event that the brand process flow server 116 performs to execute a customer journey. The sub-action(s) 142 may be unique and nested under a main action(s) 134 of the brand process flow server 116. The main action(s) 134 of the brand process flow server 116 may be modified using sub-actions 142 to change the behaviors of the flow (e.g., process flow(s) 130_{1-N}) and adapt the customer journey based on pre-defined conditions and controls, according to some embodiments. The path 144 may be the trail of action(s) 134 to be followed for resolving and/or replying to the customer's query 106. The brand process flow server 116 may come up with a logical and optimal course of action(s) 134 to resolve and/or reply to the customer's query 106 and/or customer request 108 from the pre-built template(s) 128 using the neural network 132 of the brand process flow server 116, according to some embodiments.

The response 148 may be a reply generated by the brand process flow server 116 to resolve and/or reply to the customer's query 106 and/or customer request 108 based on the path 144 identified by the brand process flow server 116, according to some embodiments.

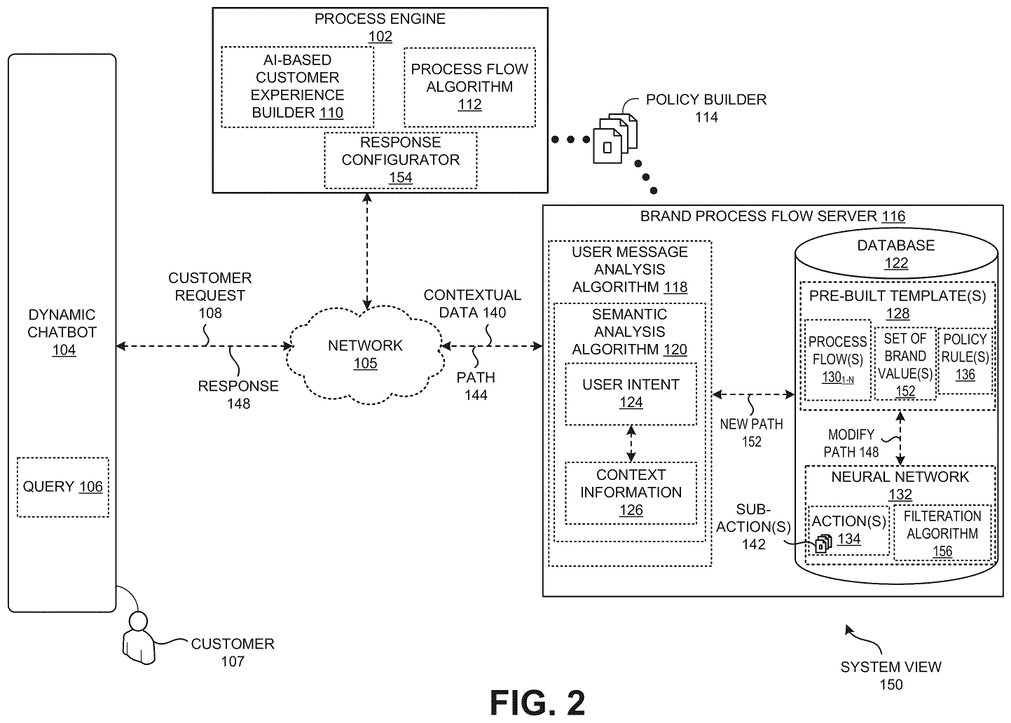

FIG. 2 is a network view 250 of the process engine 102 of FIG. 1 illustrating the generation of a new path 152 in response 130 to a customer's request 106 through logic trees enhanced with a mission and corporate values-based interaction of the customer 118 through the brand process flow server 102, according to some embodiments. Particularly, FIG. 2 builds on FIG. 1, and further adds, a modify path 148 and a new path 152, according to some embodiments. The process engine 102 may customize and/or reconfigure an action 134 of the pre-built flow templates 128 to resolve a particular use case scenario. The customized and/or reconfigured action of the process flow(s) 130 may enable the brand process flow server 116 to generate a modified (e.g., modify path 148) and/or a new path 152 to resolve the customer query 106. The modify path 148 and/or a new path 152 may include using sub-actions 142 to change the behaviors of the process flow(s) and adapt the customer journey based on predefined conditions and/or controls (e.g., using policy rule(s) 136 of the process engine 102). The use of sub-actions 142 to an existing process flow(s) 130 may generate a modify path 148 by adding on to change the underlying behavior of the workflow so that more specific use cases may be addressed in the same existing process flow(s) 130 in order to address an unexpected scenario by allowing for additional complexity in responses without having to build a new flow. Alternatively, the process engine 102 may customize new path 152 to address an unexpected scenario using sub-actions 142.

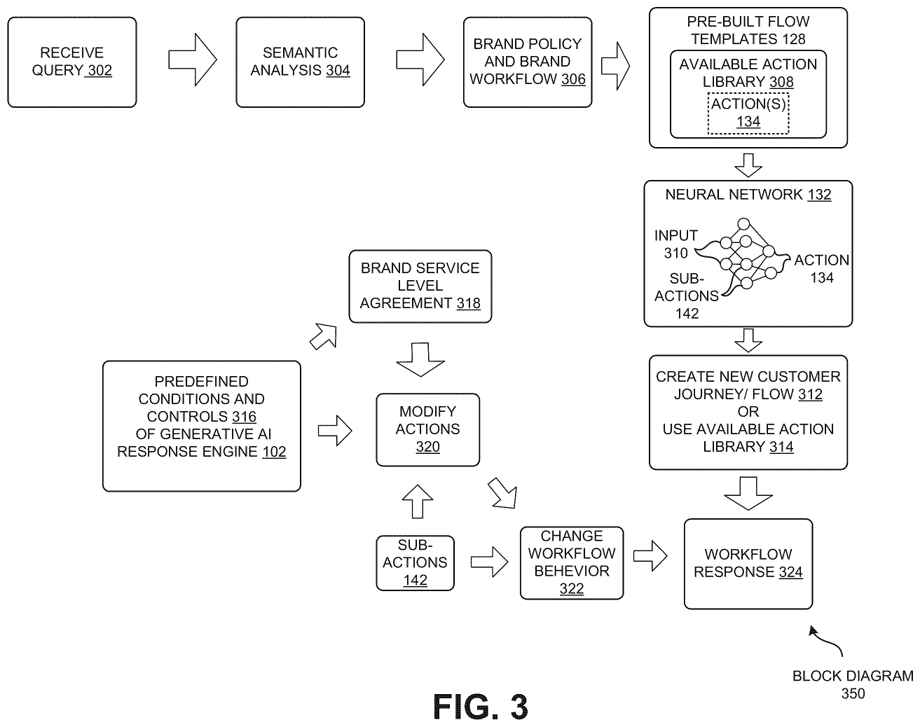

FIG. 3 is a graphical flow diagram 350 illustrating the steps involved in generating a workflow response 324 for a customer's query 106 based on the brand value(s) and brand mission by the process engine 102 of FIG. 1, according to some embodiments.

In receive query 302, the brand process flow server 116 of the process engine 102 may receive a query 106 from a customer 107 of the brand process flow server 116 through a dynamic chatbot 104 of his computing device 115 communicatively coupled to the brand process flow server 116 through a network 105. The user message analysis algorithm 118 of the brand process flow server 116 may perform the semantic analysis 304 of the query 106 received. The brand process flow server 116 may apply brand policy and brand workflow 306 to the pre-built flow templates 128 of the process engine 102. The semantic analysis 304 of the query 106 may generate an input 310 sent to the neural network 132. The neural network 132 may come up with a suggested path 138 specifying the proposed course of action(s) 134 to be followed for resolving and/or replying to the customer's query 106 and/or customer request 108 from the pre-built template(s) 128 of the brand process flow server 116. Alternatively, the process engine 102 may create new customer journey/flow 312 and/or use available action library 314 to propose a workflow response 324. The predefined conditions and controls 316 of the brand process flow server 116 may be adjusted and provided control over by the brand through the response configurator 154 of the process engine 102. The actions 134 of the process engine 102 may be modified using sub-actions 142 to change the workflow behaviors 322 and adapt the customer journey based on pre-defined conditions and controls 316 of the process engine 102.

The predefined conditions and controls 316 of the brand process flow server 116 may ensure that the modified actions (e.g., modify actions 320) for a particular use case are within the brand service level agreement 318.

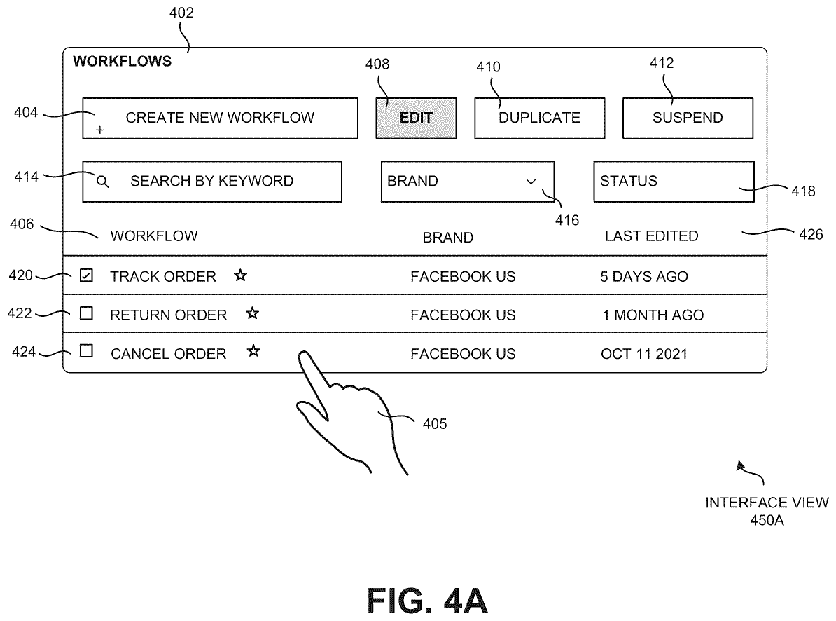

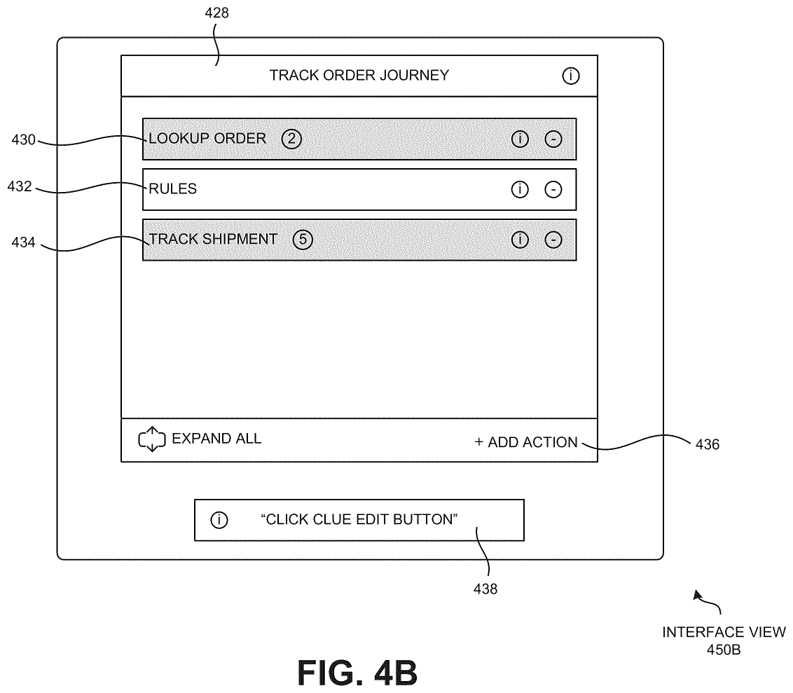

FIG. 4A is a user interface view 450A illustrating an exemplary use-case scenario of the process engine 102 of FIG. 1, according to some embodiments.

The process engine 102 may create customer service workflows in a few easy steps. The process engine 102 may allow creating the conversation flow (e.g., using the response 148 of the brand process flow server 116) for each contact reason for a customer 107, setting up brand policies (e.g., using the set of brand value(s) 152 and policy rule(s) 136 of the brand process flow server 116), previewing the workflow experience, and publishing the workflow (e.g., workflow response 324) of the brand process flow server 116) for an improved customer experience. The process engine 102 may allow its user 405 (e.g., brand owner, enterprise, etc.) to build customer response flows (e.g., track order 420, return order 422, cancel order 424, etc.) quickly and implement a cost-effective support solution while experiencing faster time turnaround.

As shown in the user interface view 450A, the process engine 102 of FIG. 1 may provide an easy navigation and control of its workflows to a brand and/or an enterprise through its interface 402. The process engine 102 may allow its brand user 405 to build and/or amend its customer response flows (e.g., workflow 406) quickly through its interface. For example, process engine 102 may provide a workflows interface 402 of its policy builder 114 to quickly navigate its various tabs in order to create and/or control its workflows (e.g., process flow(s) 130_{1-N}) for an efficient response generation (e.g., using response configurator 154) to a customer's query 106. The brand user 405 may create a new workflow 406 using a “create new workflow” 404 tab. The brand user 405 may modify and/or revise a workflow process using an edit 408 tab, create an identical and/or matching workflow 406 using a duplicate 410 tab, discontinue and/or revoke a workflow 406 using a suspend 412 tab. The Brand user 405 may search for a particular brand workflow status in the search bar “search by keyword” 414 by selecting the particular brand using the drop-down menu in the brand 416 tab and the status 418 tab. The search query may result in generating a list of various workflow(s) 106 for the selected brand and its status when the particular workflow was modified in the last edited 426 tab. The list may show the various workflows for the selected brand, such as track order 420 workflow, return order 422 workflow, and a cancel order 424 workflow for the selected brand (e.g., Facebook US, etc.).

FIG. 4B is another user interface view 450B illustrating the continuation of the exemplary use-case scenario of the process engine 102 of FIG. 1, according to some embodiments. Once the brand user 405 selects the edit 408 tab for the track order 420 workflow, the process engine 102 may present with the following track order journey 428 workflow for the selected brand 416. As shown in the user interface view 450B, the brand user 405 may be able to retrieve order information using the lookup order 430 tab. The brand user 405 may navigate to the rules 432 tab to edit and/or modify the rules (e.g., policy rule(s) 136) in a particular workflow (e.g., process flow(s) 130 of the brand process flow server 116). The brand user 405 may check the status of a particular order using the track shipment 434 tab and add up an action 134 in a particular workflow by using an add action 436 tab. The brand user 405 may use the ‘click on edit button’ 438 tab to modify a particular order journey in the respective tab.

The user interface views 450B and 450B may enable the brands and/or enterprise to change and/or modify its workflows (e.g., process flow(s) 130 of the brand process flow server 116) in its standard operating procedure in a few easy steps quickly in order to provide and maintain an improved customer experience.

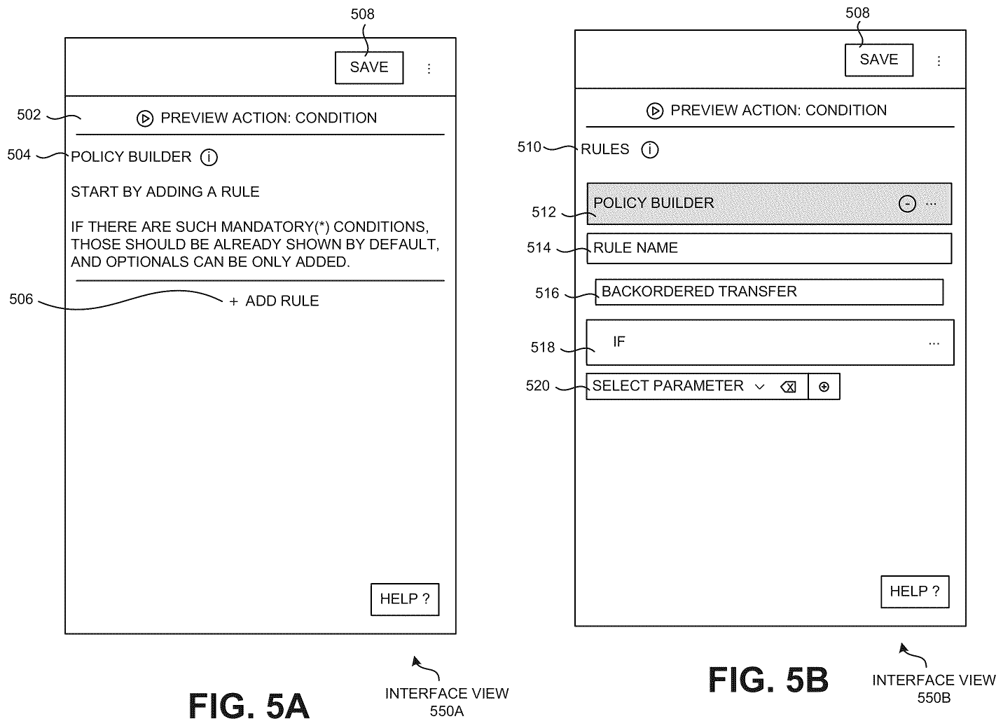

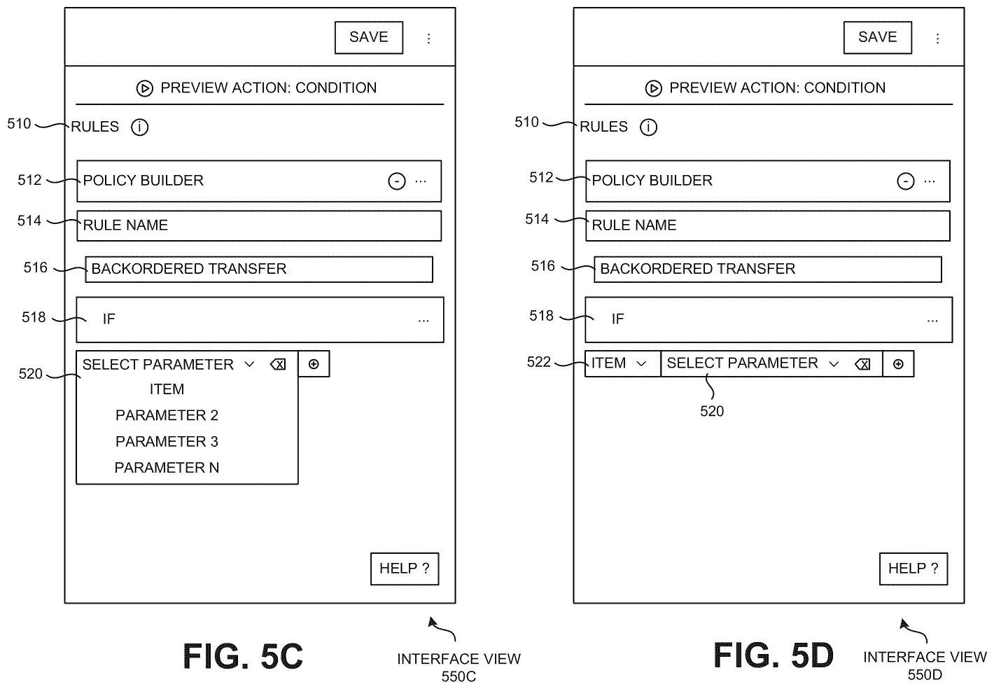

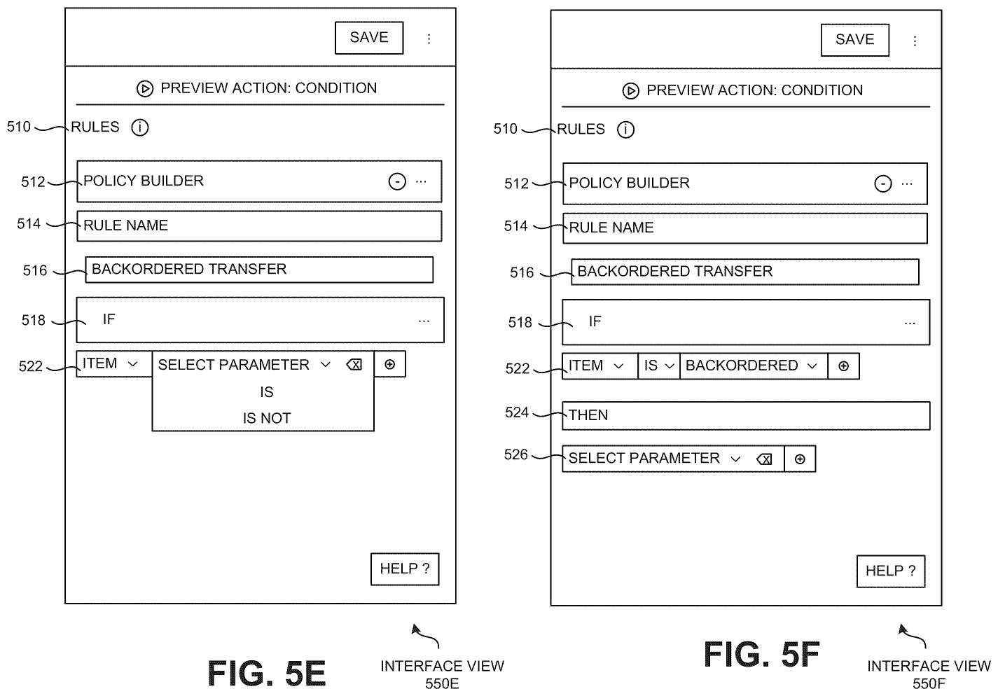

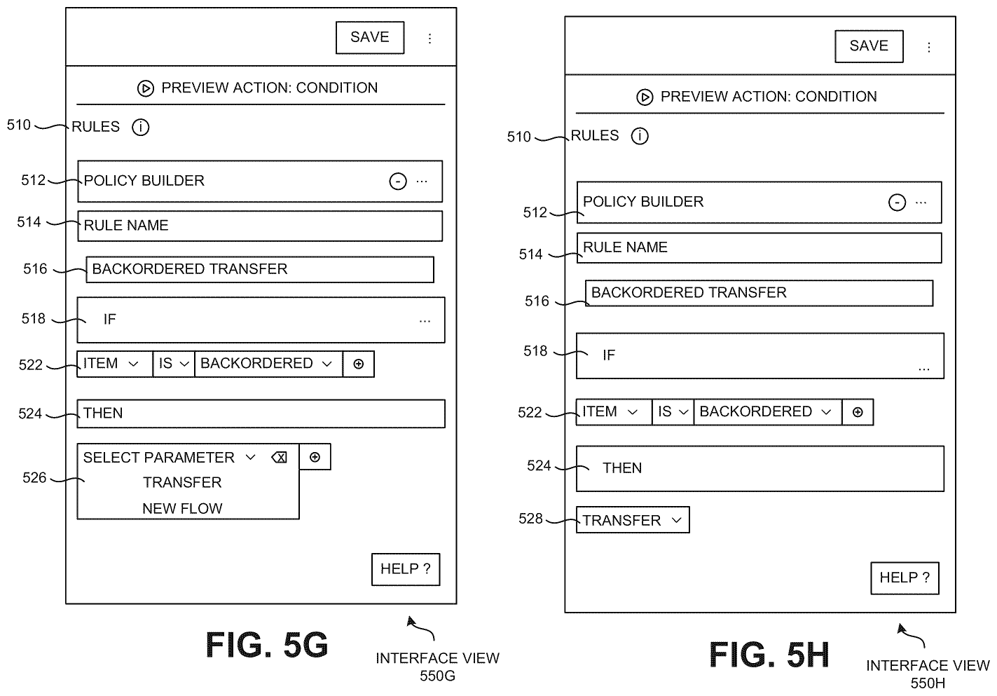

FIG. 5A-5H is an interactional user interface view of the process engine 102 of FIG. 1. The user interface view 550A illustrates an exemplary use-case scenario of the process engine 102 of FIG. 1 to customize a workflow for a particular use-case scenario of “backordered transfer”, according to some embodiments.

The interface illustrates an easy-to-create customer service workflow for each use case of a brand and/or an enterprise. As shown in FIG. 5A, a brand user 405 may define a brand policy (e.g., policy rule(s) 136) using a policy builder 504 feature of the process engine 102 for a particular workflow related to the customer service. The brand user 405 may add rule(s) 506 to define the brand policy in the specified field and may preview action 502 based on the conditions applied. The brand user 405 may save any change and/or addition in the rule using the save 508 button.

As shown in the user interface 550B of FIG. 5B, the brand user 405 may define rules 510 based on the brand mission and brand values (e.g., using the set of brand values(s) 152) for a particular workflow using the policy builder 504 tab. The brand user 405 may select the rule name 514 tab and add a label “backordered transfer” in the 516 tab to add the rule name. The brand user 405 may further add a condition—“if” by selecting the 514 tab. The brand user 405 may choose the select parameter 520 tab to navigate the conditions from the dropdown menu.

As shown in the user interface 550C of FIG. 5C, the dropdown menu of the select parameter 520 tab may show various parameters set by the brand and corresponding item for the selected workflow 406 “backordered transfer” in the 516 tab meeting the “if” condition.

The user interface 550D of FIG. 5D shows the item 522 dropdown menu for the corresponding select parameter 520 tab. The user interface 550E of FIG. 5E shows the conditions “is” and “is not” in the dropdown menu of the select parameter 520 tab for the corresponding item 522 tab. In the user interface 550F of FIG. 5F, the brand user 405 may preview the action condition for backordered transfer 516 if item 522 is backordered, then 524 tab selection may provide the option to select parameter 526 from the dropdown menu bar. The user interface 550G of FIG. 5G shows the options of select parameter 526 dropdown menu to choose from “transfer” or creating a “new flow”. The brand user 405 may select the “transfer” 528 option in the user interface view 550H of FIG. 5H for the backordered transfer 516 workflow related to the customer service to customize the workflow for the said conditions, according to some embodiments.

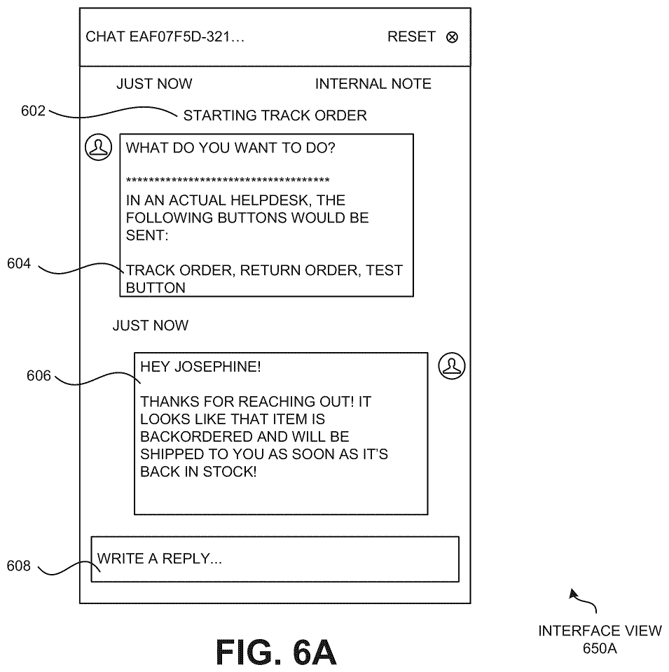

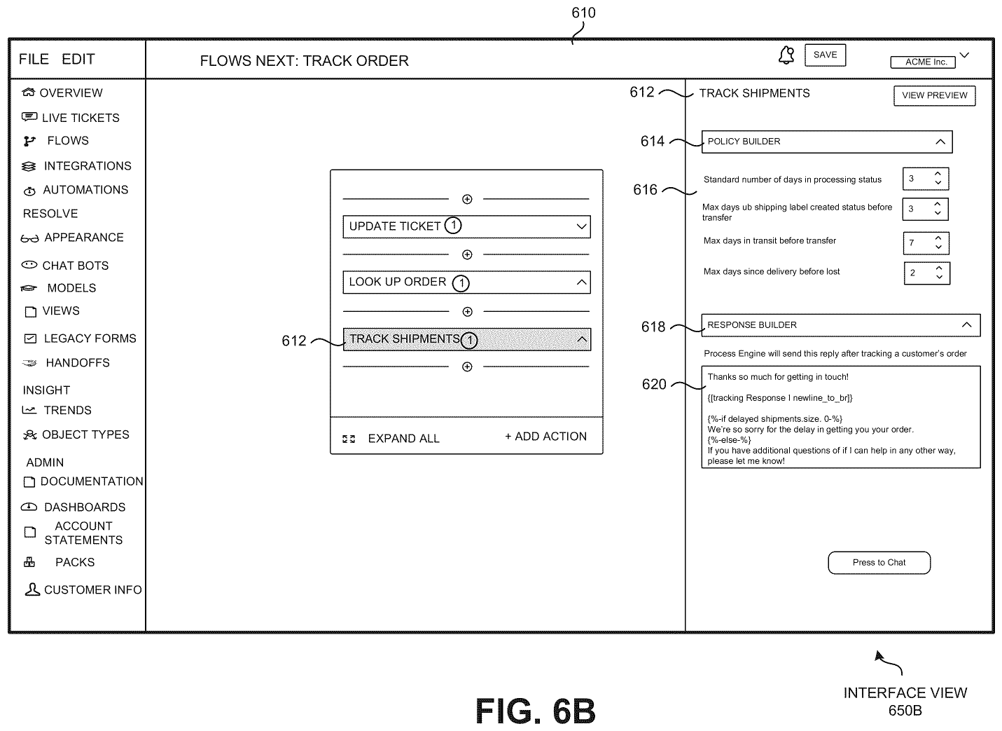

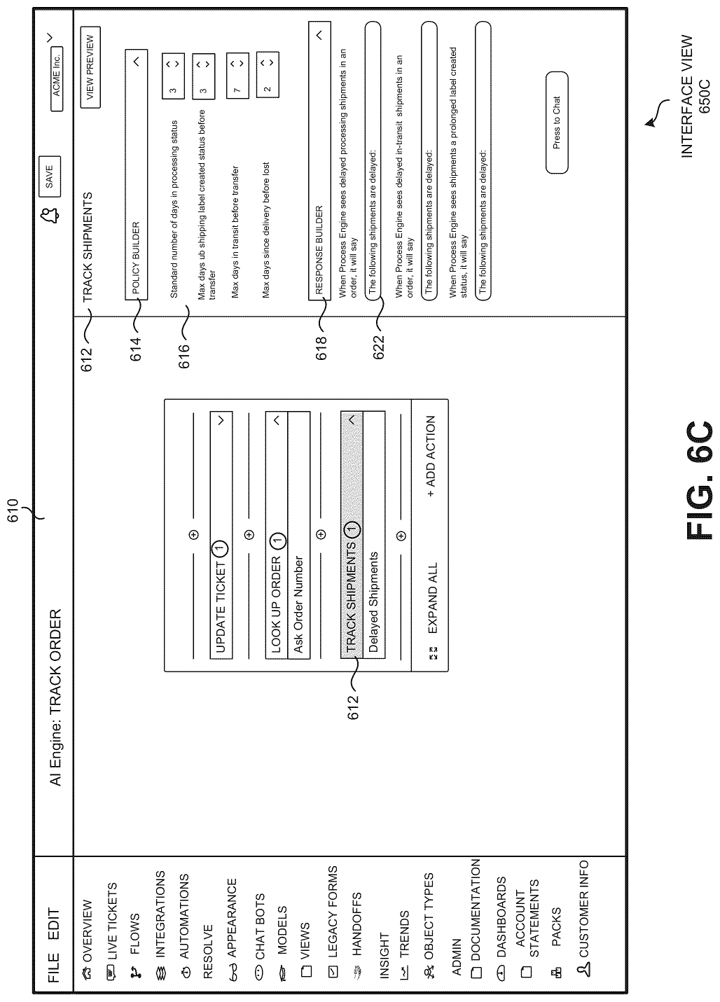

FIG. 6A-6C is a user interface view 650A illustrating an exemplary use-case scenario of the process engine 102 of FIG. 1 to configure a workflow for tracking an order using its policy builder 114 and response builder features (e.g., using response configurator 154), according to some embodiments.

In an exemplary use-case scenario of the process engine 102, the brand user 405 (e.g., brand owner, enterprise, etc.) of the brand process flow server 116 may receive a query 106 from a customer 107 related to its order through its dynamic chatbot 104. As shown in the user interface view 650, the brand process flow server 116 may help its brand user 405 to build a desired experience for its customer 107 and automatically display the start tracking order 602 window to its brand user 405. The brand process flow server 116 may present its brand user 405 with options 604 such as track order, return order, and test button etc. The dynamic chatbot 104 may automatically send a response to the customer in the 606 field. In addition, the user interface view 650, the brand process flow server 116 may present the brand user 405 (e.g., brand owner, enterprise, etc.) with an input field 608 to write a reply for the customer 107 in real-time. The brand user 405 may select track order option 604 to navigate the following user interface view 650B. The user interface view 650B shows various options for the brand user 405 to resolve the customer's query 106. The brand process flow server 116 may present the brand user 405 with prebuilt action templates 128 to help build desired experience for a particular contact reason. For example, a lookup order/action 430 plus a track shipment 434 action may trigger a track order 610 contact reason flow from the pre-built templates 128 to automatically generate and send a response 148 for the customer 107. The user interface view 650B shows the track order 610 interface. The track shipments 612 workflow may show a dropdown menu bar for policy builder 614 and the corresponding response builder 618 dropdown menu bar for the brand user 405 to set up a timeline for each action response based on the processing status of the order in 616 field. Analogous to the policy builder 614 dropdown menu bar, the process engine 102 may provide a response builder 618 dropdown menu bar with automated response trigger options in the 620 field. The brand user 405 may select the response builder 618 menu to set up a trigger for an automated response 148 for the particular use case scenario to build desired experience for the customer.

The user interface view 650C illustrates a use case scenario for tracking an order when delayed shipments is identified by the process engine 102 of FIG. 1. The process engine 102 may send an automated response 148 from the prebuilt response templates 622 to help build desired experience for the customer 107, according to some embodiments.

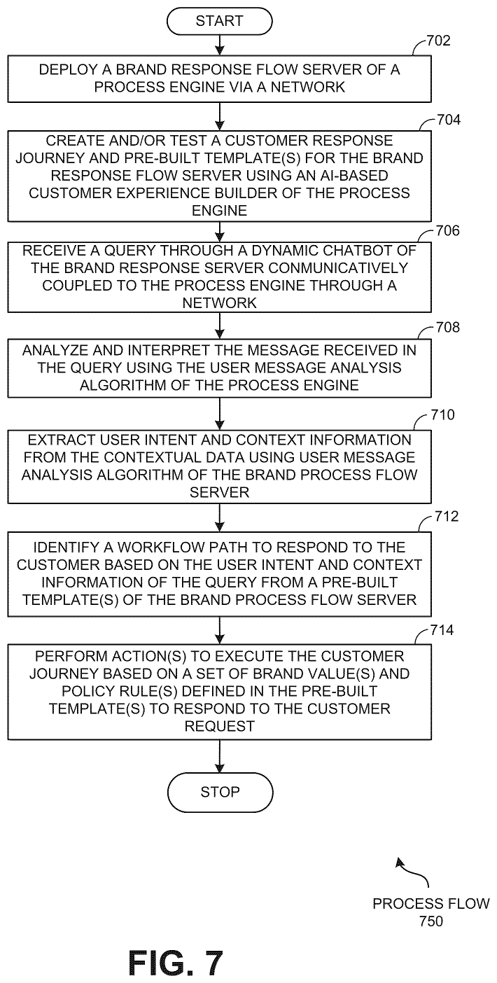

FIG. 7 is a process flow 750 detailing the operations involved in setting up an artificial intelligence-powered contextual customer service through logic trees enhanced with a mission and corporate values-based interactions of the process engine 102 of FIG. 1 using generative AI prompts to control the responses, according to some embodiments.

In operation 702, the method may deploy a brand response flow server 116 of a process engine 102 via a network 105, according to some embodiments. In operation 704, the method may create and/or test a customer response journey and pre-built template(s) 128 for the brand response flow server 116 using an AI-based customer experience builder 110 of the process engine 102, according to some embodiments.

In operation 706, the method may receive a query 106 through a dynamic chatbot 104 of the brand response server 116 communicatively coupled to the process engine 102 through the network 105. In operation 708, the method may analyze and interpret the message received in the query 106 using the user message analysis algorithm 118 of the process engine 102.

In operation 710, the method may extract user intent 124 and context information 126 from the contextual data 140 using the user message analysis algorithm 118 of the brand response server 116. In operation 712, the method may identify a workflow path to respond to the customer 107 based on the user intent 124 and context information 126 of the query 106 from a pre-built template(s) 128 of the brand process flow server 116. In operation 714, the method may perform action(s) 134 to execute the customer journey based on a set of brand value(s) 152 and policy rule(s) 136 defined in the pre-built template(s) 128 to respond to the customer request 108, according to some embodiments.

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in some embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, or steps. Thus, such conditional language is not generally intended to imply that features, elements, or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

We claim:

1. A method comprising:
creating a customer response flow having one or more pre-built templates for handling responses for a brand, each of the one or more pre-built templates having a series of step-by-step actions with controls and generative artificial intelligence (AI) response prompts;
receiving a query from a user through a dynamic chatbot;
determining user intent and context information based on the query;
identifying a workflow path to respond to the customer, based on the user intent and context information, from one or more pre-built templates; and
performing one or more actions to execute the customer response flow based on a set of one or more brand values and one or more policy rules set forth in the one or more pre-built templates to respond to the request.

2. The method of claim 1 further comprising using AI to evaluate a message and determine which of a plurality of paths to take and execute in the customer response flow.

3. The method of claim 1 further comprising adapting the customer response flow based on brand-defined generative AI prompts.

4. The method of claim 1 further comprising altering one or more responses of one or more of the pre-built templates by configuring an action of the step-by-step actions using a user interface.

5. The method of claim 1 further comprising dynamically modifying a response to the query based on conditions set by the brand.

6. The method of claim 1 wherein the query comprises a request for customer assistance.

7. The method of claim 1 wherein determining user intent and context information based on the query comprises analyzing and interpreting a message in the query using a user message analysis algorithm.

8. A tangible, non-transitory, computer-readable media having instructions thereupon which, when executed by a processor, cause the processor to perform a method comprising:
creating a customer response flow having one or more pre-built templates for handling responses for a brand, each of the one or more pre-built templates having a series of step-by-step actions with controls and generative AI response prompts;
receiving a query from a user through a dynamic chatbot;
determining user intent and context information based on the query;
identifying a workflow path to respond to the customer, based on the user intent and context information, from one or more pre-built templates; and
performing one or more actions to execute the customer response flow based on a set of one or more brand values and one or more policy rules set forth in the one or more pre-built templates to respond to the request.

9. The tangible, non-transitory, computer-readable media of claim 8 further comprising using AI to evaluate a message and determine which of a plurality of paths to take and execute in the customer response flow.

10. The tangible, non-transitory, computer-readable media of claim 8 further comprising adapting the customer response flow based on brand-defined generative AI prompts.

11. The tangible, non-transitory, computer-readable media of claim 8 further comprising altering one or more responses of one or more of the pre-built templates by configuring an action of the step-by-step actions using a user interface.

12. The tangible, non-transitory, computer-readable media of claim 8 further comprising dynamically modifying a response to the query based on conditions set by the brand.

13. The tangible, non-transitory, computer-readable media of claim 8 wherein the query comprises a request for customer assistance.

14. The tangible, non-transitory, computer-readable media of claim 8 wherein determining user intent and context information based on the query comprises analyzing and interpreting a message in the query using a user message analysis algorithm.

15. A computer-based flow server for customer assistance comprising:
a memory; and
a process engine coupled to the memory to:
create a customer response flow having one or more pre-built templates for handling responses for a brand, each of the one or more pre-built templates having a series of step-by-step actions with controls and generative AI response prompts;
receive a query from a user through a dynamic chatbot;
determine user intent and context information based on the query;
identify a workflow path to respond to the customer, based on the user intent and context information, from one or more pre-built templates; and
perform one or more actions to execute the customer response flow based on a set of one or more brand values and one or more policy rules set forth in the one or more pre-built templates to respond to the request.

16. The computer-based flow server of claim 15 wherein the process engine is configured to use AI to evaluate a message and determine which of a plurality of paths to take and execute in the customer response flow.

17. The computer-based flow server of claim 15 wherein the process engine is configured to adapt the customer response flow based on brand-defined generative AI prompts.

18. The computer-based flow server of claim 15 wherein the process engine is configured to alter one or more responses of one or more of the pre-built templates by configuring an action of the step-by-step actions using a user interface.

19. The computer-based flow server of claim 15 wherein the process engine is configured to dynamically modify a response to the query based on conditions set by the brand.

20. The computer-based flow server of claim 15 wherein the query comprises a request for customer assistance.
